(19) United States
(12) Patent Application Publication
(10) Pub. No.: US 2008/0180727 A1
(43) Pub. Date: Jul. 31, 2008

(54) Print workflow methods and printing system apparatuses

(76) Inventors: Ehud Chatow, Palo Alto, CA (US); Keith Moore, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/700,752

(22) Filed: Jan. 30, 2007

(51) Int. Cl. H04N 1/00

(52) U.S. Cl. 358/1.15

(57) ABSTRACT

Print workflow methods and printing system apparatuses are described in some embodiments. According to one embodiment, a print workflow method includes providing a job to be printed upon media comprising arranging a plurality of elements into a desired layout for a page of the job and tagging individual ones of the elements of the job with respective ones of a plurality of different tags, and hard imaging the job in a plurality of separations and according to the tags, the hard imaging comprising accessing the job comprising the elements and the respective tags of the page, processing the page of the job for printing, and after the processing, printing the page of the job comprising the plurality of elements, and after the printing, finishing the job, and wherein at least one of the processing, the printing and the finishing for a single one of the separations comprises processing, printing, or finishing different ones of the elements of the page differently according to the respective tags.

### FIELD OF THE DISCLOSURE

Aspects of the disclosure relate to print workflow methods and printing system apparatuses.

### BACKGROUND OF THE DISCLOSURE

Multistage print workflows are used to generate numerous copies of various print jobs. The print workflows may include a plurality of stages to perform respective operations with respect to printing the job. Supervision and verification may be performed by one or more individuals during the different stages of the workflow to monitor the progress of the job in view of the intent of the creator of the respective job. Typically, the author may specify page level printing specifications which are uniformly applied to an entirety of a page during the print workflow. Furthermore, different stages of multistage print workflows are typically dependent and interdependencies of the stages may lead to numerous iterations of printing, correcting and re-printing of the job to achieve faithful reproductions of the intended job as specified by the creator.

Some embodiments of the present disclosure describe improved apparatus and methods for implementing print workflows.

### SUMMARY

According to some aspects of the disclosure, print workflow methods and printing system apparatuses are described.

According to one aspect, a print workflow method comprises providing a job to be printed upon media comprising arranging a plurality of elements into a desired layout for a page of the job and tagging individual ones of the elements of the job with respective ones of a plurality of different tags, and hard imaging the job in a plurality of separations and according to the tags, the hard imaging comprising accessing the job comprising the elements and the respective tags of the page, processing the page of the job for printing, and after the processing, printing the page of the job comprising the plurality of elements, and after the printing, finishing the job, and wherein at least one of the processing, the printing and the finishing for a single one of the separations comprises processing, printing, or finishing different ones of the elements of the page differently according to the respective tags.

According to another aspect, a printing system apparatus comprises processing circuitry configured to access a job to be printed, wherein the job comprises a page comprising a plurality of elements and a plurality of tags associated with respective ones of the elements, wherein the processing circuitry is configured, for an individual one of the elements, to process the respective tag associated with the individual one of the elements and to modify image data of the one of the elements according to the respective tag associated with the one of the elements, and a print engine coupled with the processing circuitry and configured to print the page comprising the plurality of the elements, and wherein the print engine is configured to print the one of the elements using the image data after the modification.

Other embodiments and aspects are described as is apparent from the following discussion.

### DESCRIPTION OF THE DRAWINGS

FIG. 1 is a graphical illustration of a page of a printed job according to one embodiment.

FIG. 2 is an illustrative representation of a printing system configured to implement a print workflow according to one embodiment.

FIG. 3 is a functional block diagram of a printing system apparatus configured to perform one or more operation of a print workflow according to one embodiment.

FIG. 4 is a flow chart of a print workflow method according to one embodiment.

FIG. 5 is an illustrative representation of a print workflow according to one embodiment.

FIG. 6 is a flow chart of a print workflow method including varnishing according to one embodiment.

### DETAILED DESCRIPTION

Some embodiments of the disclosure disclose print workflow methods and printing systems. As described in detail below according to one embodiment, one or more entities may perform operations with respect to a print workflow for printing a job. In one print workflow example, an author may create a job including one or more page to be printed. Individual pages may include one or more element to be printed. In one embodiment, individual elements are associated (tagged) with respective tags. The tags specify operations to be performed for the respective elements during the print workflow and the operations may be tailored to content of the respective elements. In one embodiment, certain processing of elements of a job may occur prior to printing to accommodate changes to the elements after the printing, for example, in a finishing stage (e.g., varnishing or lamination). These and other embodiments are described below.

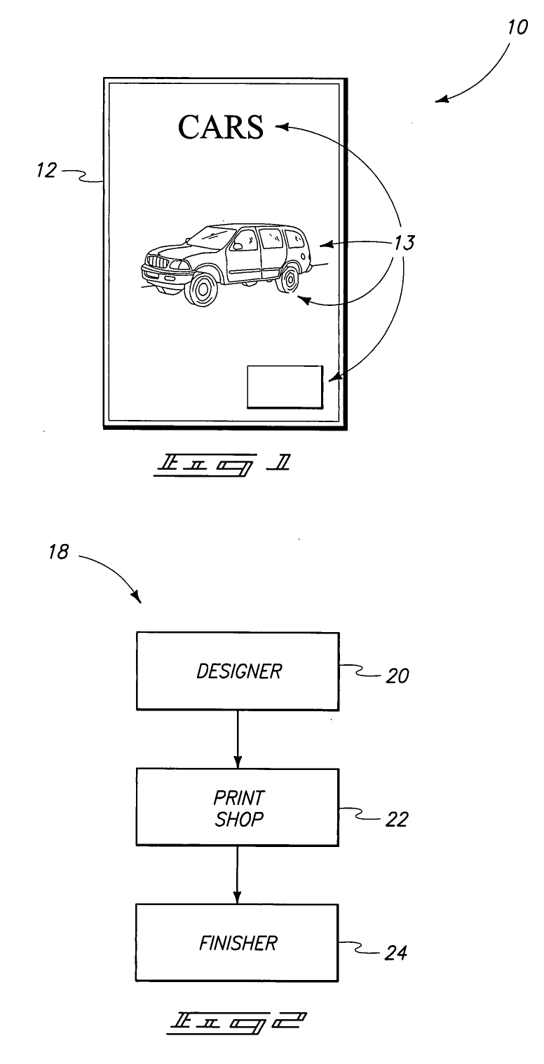

Referring to FIG. 1, a hard copy image in the form of a printed job 10 is shown in the depicted embodiment. The printed job 10 shows a single page, but other jobs may include a plurality of different pages. Printed jobs 10 may include numerous copies of the same content (e.g., catalogs, magazines, brochures, mailings in some examples) and may be color, and/or monochrome.

Page 12 of FIG. 1 includes a plurality of elements 13 which correspond to portions of page 12 which may be processed, printed and finished differently. Elements 13 may be used to define different regions of a page and specify how the respective regions will be processed, printed, and finished. For example, different elements 13 may include text, drawings, graphics, and pictures of a page. In the example of FIG. 1, different elements 13 include the text “CARS,” a body of the vehicle, a wheel of the vehicle, and a mass mailing region. For example, image data (e.g., digital data) of a single element 13 may be processed, printed and finished in the same fashion and which may be different from processing, printing and finishing of image data of one or more other element 13 of the same page. Referring to the specific example of FIG. 1, it may be desired to apply a varnish to only some of the elements 13 (e.g., apply varnish only to the wheels of the vehicle) while leaving other portions of the vehicle and page unvarnished.

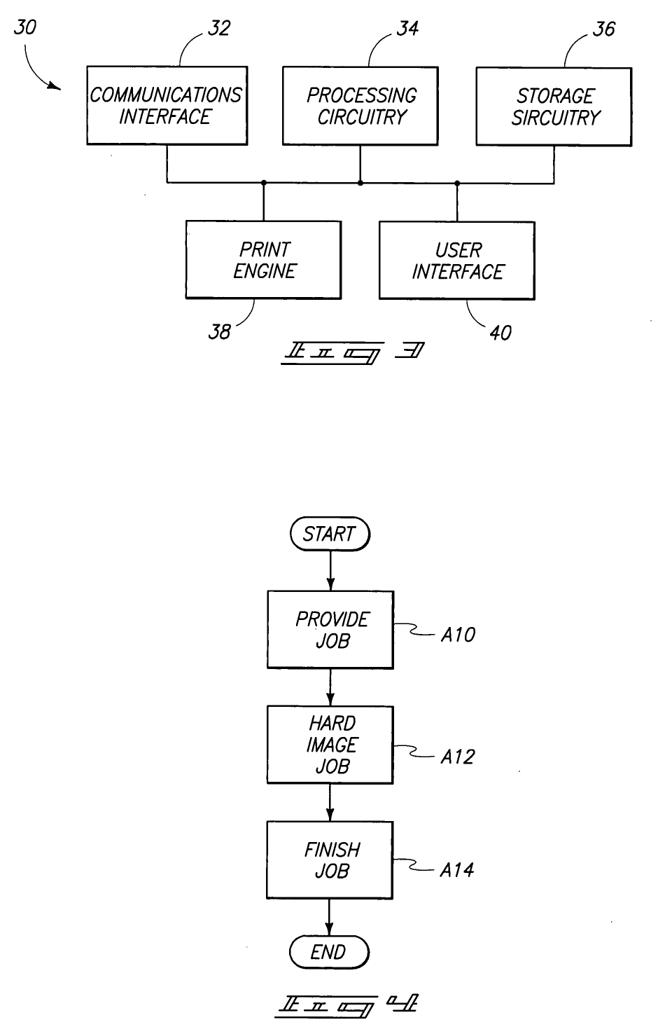

Referring to FIG. 2, one example of a plurality of entities of a printing system 18 configured to create, process, print and finish a job is shown. A plurality of different entities of the system 18 include a designer 20, print shop 22, and a finisher 24 in the example of FIG. 2. Other embodiments may include less (e.g., one entity) or additional entities to implement a print workflow. The entities may individually include a printing system apparatus such as shown in FIG. 2 to assist with performing respective operations with respect to the print workflow.

In one embodiment, designer 20 represents an individual, such as an author, who may utilize a respective printing system apparatus (e.g., computer) to design a job to be printed upon media (e.g., paper). In one job creation implementation, designer 20 imports a job ticket template from print shop 22 into an authoring tool (e.g., Photoshop, CreativeSuite, PowerPoint, Word, or other suitable application). The job ticket template describes a type of job being created (e.g., flatwork, multiple page booklet, multiple page book, etc.), a size of page(s) of the job (e.g., A4, A3, B2, C, D, etc.), properties of the page (e.g., US Coated SWOP, US Uncoated SWOP, etc.) and colors of the final set (e.g., L*A*B*, CMYK-SWOP, aRGB, sRGB, CMYKcm, CMYKOV, CMYKOVG, etc.), and finishing options (e.g., varnishing, lamination, stapling, hole drilling, trimming, binding, gluing, etc.).

In one embodiment, the author of the designer 20 utilizes an authoring tool to design and arrange content for each page of a job. The author of the designer 20 may arrange a plurality of elements into a desired layout for one or more page during page creation of a job to create the job. The author and apparatus of the designer 20 may specify the appearance of the job to be produced. In one embodiment, designer 20 may specify the appearance of the plurality of elements of respective pages of the job including specifying the appearances of some elements to be different from other elements. In one embodiment, the designer 20 may implement tagging wherein individual elements are tagged (e.g., associated) with respective tags which specify how the respective elements are to be subsequently processed, printed and finished during the print workflow (and which specify how the elements will appear in the final produced output). Referring again to FIG. 1, an author may tag the elements 13 in a manner to specify that the wheels are to be varnished for a gloss effect and the tags may identify a desired specific varnish to be used in one embodiment.

In a more specific example, designer 20 may lay elements 13 down onto page 12 while composing the job. Designer 20 may specify the size and type of a job and respective elements 13 (e.g., properties, colors, processing, finishing options, etc.). In one example, designer 20 may adjust colors (e.g., RGB, L*A*B*) to a desired color and may specify specific colors (e.g., HP Blue, Pantone 514C, etc.) which may be mixed or spot. Specified varnishes or laminates may be named as transparent colors which are not shown but may be acted on by the remainder of the system as described below.

Imposition may be performed in one print workflow embodiment where the author flows the pages of the job into the ticket template to construct the actual job and perhaps preview the job. The job may be generated in an Author format (e.g., .ppd, .mif, .dooc, etc.) and the job ticket may be custom in one embodiment. Designer 20 may also perform job normalization where the job is rendered into a standard production or neutral format (e.g., PDF-x1a, PDF-3x, or generic PDF where content of the job ticket may be derived from the template such as JDF describing colorants, impositions, substrate mapping and finishing options).

Job submission may be performed by designer 20 in one print workflow embodiment where the job may be checked for gross errors (e.g., whether parts are available, pre-flighting). Generated files of the job may be relatively large (e.g., >2GB). The job may be transferred if the print shop 22 is implemented as an entity separate from designer 20 (e.g., the internet or a DVD may be used to transfer the job to another entity in some illustrative examples). Billing estimates may be created by designer 20 which indicate rough costs of the creation of the job.

In one embodiment, print shop 22 may represent an individual and print system apparatus for hard imaging the job (e.g., forming an image upon media such as by printing the job by applying marking agents to media). Print shop 22 may receive the file from designer 20 and access the job comprising a layout of the elements (and respective tags of the elements) of one or more page of the job in one embodiment. Print shop 22 may perform desired processing of the elements which may be specified by the respective tags to prepare the job for printing. In one embodiment, print shop 22 may process the job for printing using a specific printer of the print shop 22 and may thereafter print the job using the printer.

Print shop 22 may perform job assembly operations in one example. The job ticket and job may be validated and pre-flighted to determine if the images, colors, fonts and other parts of the job are available at the print shop 22. A time estimation regarding the processing of the job may be performed. If variable content is present in the job (e.g., mailing addresses for the mailing address region element 13 of FIG. 1), the content may be checked and a proof may be made available to a customer. The job assembly operations may provide a PDF file with a JDF job ticket where the PDF has been normalized and certified as valid for print shop 22. Print shop 22 may additionally archive the job.

Print shop 22 may next perform pre-print/pre-press operations where a specific output device is selected to print the job. Colorants of a color job may be mapped to available colorants of the printer (e.g., an RGB job may be converted to a CMYKOVG job or spot colors may be mapped to process colors if a spot is unavailable).

Image enhancement operations of one or more of the elements may be performed corresponding to respective tags of the elements. Example operations of image enhancement may be to increase or decrease resolution, sharpening, gloss correction, adjustment of tone-reproduction curves, deepening of blacks to widen to a larger gamut, and gamut clipping correction/widening of pictures. The adjustment may be a mapping from a colorimetric or faithful reproduction to a perceptual reproduction (e.g., expanding the dynamic range of the color gamut is a perceptual mapping). In one embodiment, proofs of the job may be generated on the printer to be utilized or on a soft/hard proof device for validation. Proofs typically do not have varnishes or laminates applied. In one embodiment, device trap items, such as bleed restrictions, bleed directions, containment, and OPI or VDP proofing/merge may occur during the pre-print/pre-press.

Print shop 22 may next perform device rendering operations in a RIP stage in one embodiment. Other jobs which have similar colorants and media substrates may be ganged with the present job. Transformation (e.g., ICC color translation) to convert an input format PPML/PDF and JDF of the job into a device bitmap/raster/object format and device colorants may be performed in one embodiment. For example, with a LaserJet(R) available from Hewlett-Packard Company, the PDF may be converted to PCL-3 or mapped all the way to a 1-bit TIFF image. For platesetters, the 1-bit TIFF may be a typical representation with plates separated based on the colorant space of the printer. In addition to ripping of the job, printing occurs where the pages of the job are formed on media. Output from the print shop 22 may be a job ticket, encoded as a barcode or a printed worksheet, and printed pages (collated or uncollated).

The job may next be processed by finisher 24. In one embodiment, finisher 24 may represent an individual and printing system apparatus for finishing the job. The job ticket information for the job is read (e.g., a real job ticket may be retrieved or the operator may enter job ticket instructions into the finisher 24). In accordance with instructions (e.g., which may be defined by the tags), the job may be one or more of collated, inserted, stuffed, varnished, laminated, trimmed, prepared for mailing, or additional operations performed. Mailing labels may be attached at the mailing region element 13 of the page 12 shown in FIG. 1 for a plurality of copies. Output from the finisher 24 is a set of finished documents in one embodiment.

Referring to FIG. 3, an embodiment of a printing system apparatus 30 which may be implemented in one or more of designer 20, print shop 22, and finisher 24 is shown. The illustrated apparatus 30 includes a communications interface 32, processing circuitry 34, storage circuitry 36, print engine 38, and user interface 40. Other embodiments of apparatus 30 are contemplated and apparatus 30 may include more, less or alternative components in different configurations for designer 20, print shop 22 or finisher 24. For example, print engine 38 may only be present in a configuration of apparatus 30 of print shop 22 and corresponds to a printer. In another example, a configuration of apparatus 30 utilized by finisher 24 may include one or more finishing components to implement desired finishing.

Communications interface 32 is arranged to implement communications of apparatus 30 with respect to external devices (not shown). Communications interface 32 may be implemented in any suitable configuration to communicate a job with respect to apparatus 30.

In one embodiment, processing circuitry 34 is arranged to process image data, control data access and storage, issue commands, and control other desired operations. For example, processing circuitry 34 of apparatus 30 of print shop 22 may access the received job, process tags of elements of the job, and modify image data of the elements according to the tags as described in examples below.

Processing circuitry 34 may comprise circuitry configured to implement desired programming provided by appropriate media in at least one embodiment. For example, the processing circuitry 34 may be implemented as one or more of a processor and/or other structure configured to execute executable instructions including, for example, software and/or firmware instructions, and/or hardware circuitry. Exemplary embodiments of processing circuitry 34 include hardware logic, PGA, FPGA, ASIC, state machines, and/or other structures alone or in combination with a processor. These examples of processing circuitry 34 are for illustration and other configurations are possible.

The storage circuitry 36 is configured to store programming such as executable code or instructions (e.g., software and/or firmware), electronic data, databases, image data, or other digital information and may include processor-usable media. Processor-usable media may be embodied in any computer program product(s) or article of manufacture(s) which can contain, store, or maintain programming, data and/or digital information for use by or in connection with an instruction execution system including processing circuitry 34 in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information.

At least some embodiments or aspects described herein may be implemented using programming stored within appropriate storage circuitry described above and/or communicated via a network or other transmission media and configured to control appropriate processing circuitry 34. For example, programming may be provided via appropriate media including, for example, embodied within articles of manufacture, embodied within a data signal (e.g., modulated carrier wave, data packets, digital representations, etc.) communicated via an appropriate transmission medium, such as a communication network (e.g., the Internet and/or a private network), wired electrical connection, optical connection and/or electromagnetic energy, for example, via a communications interface, or provided using other appropriate communication structure or medium. Exemplary programming including processor-usable code may be communicated as a data signal embodied in a carrier wave in but one example.

Print engine 38 may be provided in a configuration of apparatus 30 utilized by a print shop. The print engine 38 may be configured to print pages of the job to hard image the job (e.g., providing a marking agent such as ink or toner onto media). Print engine 38 may utilize a plurality of colorants to form color images in one embodiment. Print engine 38 may be configured as an electrophotographic engine or inkjet engine in illustrative configurations.

User interface 40 is configured to interact with a user including conveying data to a user (e.g., displaying data for observation by the user, audibly communicating data to a user, etc.) as well as receiving inputs from the user (e.g., tactile input, voice instruction, etc.). Accordingly, in one exemplary embodiment, the user interface 40 may include a display (e.g., cathode ray tube, LCD, etc.) configured to depict visual information and an audio system as well as a keyboard, mouse and/or other input device. Any other suitable apparatus for interacting with a user may also be utilized.

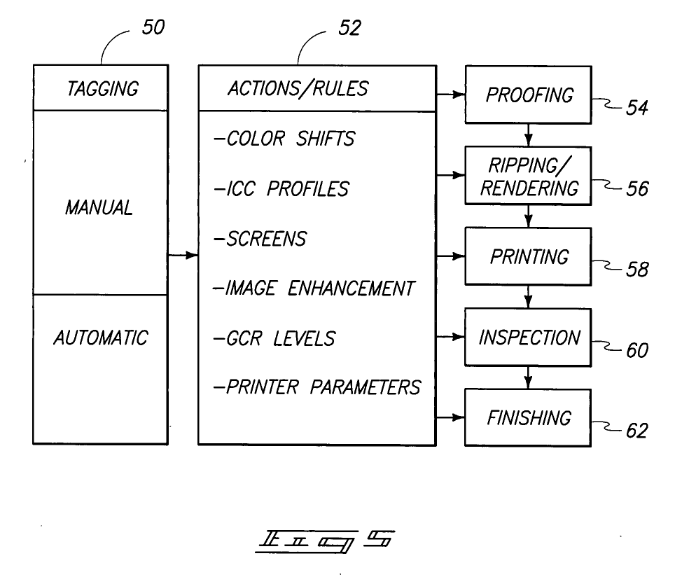

Referring to FIG. 4, one embodiment of a print workflow method is shown. The print workflow method may be performed by one or more of the entities of FIG. 2 in one embodiment. Other print workflow methods are contemplated including more, less or alternative acts.

At an act A10, the job to be printed is provided. In one embodiment, an author uses an authoring tool to create the job comprising one or more page. Individual pages may include one or more element. The elements may be tagged to specify subsequent operations to be performed with respect to the elements during processing, printing and finishing the job. The tags may specify that different operations be performed for different ones of the elements of a common page of the job in one embodiment. For example, image data of different elements of a page may be processed differently, printing of the elements may be different, and finishing of the elements may be different according to the tags.

At an act A12, the job is forwarded to a print shop to hard image the job upon media. The print shop may perform job assembly operations, preprint workflow operations, ripping/rendering operations, and printing of the job. In one embodiment, at least some of the operations performed by the print shop with respect to elements may be specified or controlled by the tags of the elements.

At an Act A14, the printed job is finished. One or more of the operations for finishing the elements of the job may be controlled by the tags of the elements in one embodiment.

As discussed above, tags may be utilized in one embodiment to specify or control different operations to be performed with respect to one or more of processing, printing and finishing of respective elements of one or more page of the job. Tags for different elements of a single page of the job may specify different processing, printing and finishing of the elements. One embodiment for tagging elements of a job and implementing processing, printing and finishing of the elements according to respective tags is described below.

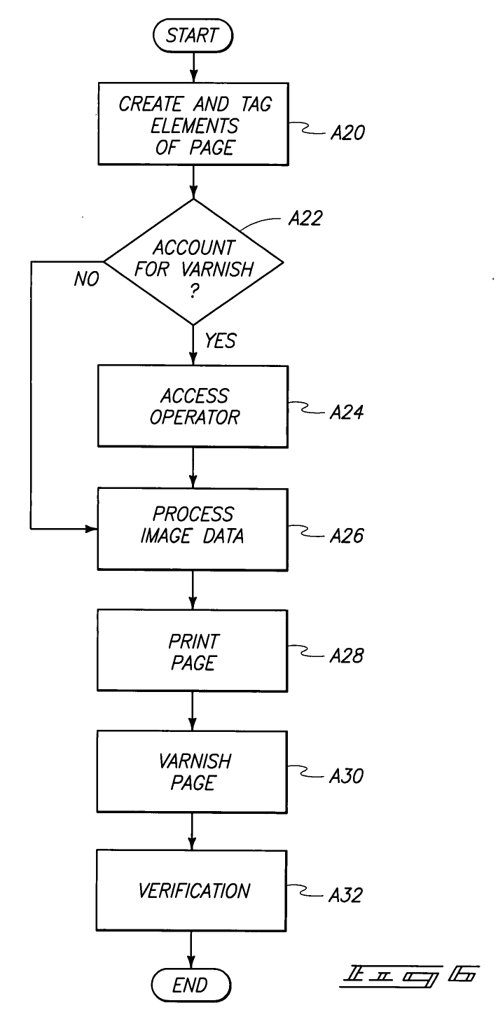

Referring to FIG. 5, elements of the job are tagged and the tags specify one or more actions or rules which are to be invoked to control proofing/inspection, processing, printing and finishing of the respective individual elements of the job.

Box 50 corresponds to tagging of elements in one embodiment. Tagging may be manual (e.g., one or more elements are tagged with respective tags by the author) or automated (e.g., one or more elements are tagged with respective tags by processing circuitry in the absence of input by an author defining the tags).

Manual tagging examples include defining, for an element, one or more of a varnish, laminate or that the element includes variable content. Tags may be associated with elements responsive to user input provided by the user interface of the designer in one example. A varnish tag may identify the type of varnish to be applied to an element during finishing as well as the gloss level of the varnish in one embodiment. A laminate tag may identify a type of laminate to be applied to an element during finishing as well as the gloss level of the laminate in one embodiment. An element may be tagged as including variable content (e.g., a mailing region to be printed with different mailing addresses).

Automated tagging examples include associating tags which define image enhancements with picture elements and associating tags which identify types of content present in respective elements. In one embodiment with respect to a picture element, processing circuitry may access information regarding a specified picture element (e.g., a header of a picture) and automatically select an appropriate tag for the respective picture element. In one example, the processing circuitry may also access information regarding the type of job to be produced (e.g., poster, thumbnail) and automatically select the respective tag to be associated with the picture element for the job to be produced. The tag may specify one or more image enhancement (e.g., sharpening, smoothing, contrast) appropriate to the contents of the header information as well as the type of output to be generated.

Additional automated tagging may include identifying the type of content of respective elements (e.g., text, graphics, pictures) and automatically assigning tags for the elements which indicate the respective types of content of the elements for subsequent use in the print workflow. The tags identifying the type of content of the elements may be used to select different screens and color transformation profiles appropriate for the type of content in some examples as described below.

Box 50 corresponds to tagging by designer 20 of FIG. 2 in one embodiment. Tags may also be associated with the elements at other times during the print workflow in one embodiment. For example, tags may be associated with one or more element by a print shop 22 of FIG. 2 during job assembly (e.g., by an assembler). In addition, the above-described tag examples are for illustration of one embodiment. Other tags may be defined and used in a print workflow.

Box 52 corresponds to actions or rules which may be selected by appropriate processing circuitry for the elements responsive to the respective tags. In one embodiment, different actions or rules may be selected for different elements of a given page. The actions or rules control operations performed with respect to the elements during subsequent portions of the print workflow. In the depicted example, the actions or rules may control shifts of image data, selection of International Color Consortium (ICC) profiles, selection of screens, selection of image enhancements, selection of grey component replacement (GCR) levels, and selection of printer parameters. Other actions or rules may be utilized in other embodiments.

One example for implementing the actions or rules is described with respect to processing of a tag which identifies material to be applied over an element during finishing (e.g., a specific varnish or laminate for an element). Varnishes or laminates may be applied to one or more elements during finishing of the job and, once applied, the varnishes or laminates may alter the spectral properties of previously printed colors of the elements. In one embodiment, the actions or rules modify image data content of the elements, for example by implementing color shift operations, prior to printing of the elements of the job (e.g., during ripping) and which correspond to and take into account the types of finishing of the elements (e.g., and the alteration of the colors by the types of finishing after the printing).

In box 52, a color shift of image data of an element to correct the shift provided by the varnish or laminate may be determined by an operator, such as an algorithm, color shift look up table (LUT) or other arrangement, which is addressed according to the type of varnish or laminate identified by the tag. The color shift operator may be generated by direct measurement or by mathematical model of spectral influence in some embodiments. The output of the color shift operator may be used to select an appropriate color transformation for the respective element via an ICC profile in the illustrated example to account for the color shift provided by the type of varnish or laminate to be used. Accordingly, in one embodiment, the author may design the job such that one of the elements is to be printed according to a desired specification (e.g., a desired color). In one embodiment, the specification for the respective element provided by the author may be modified to a different specification corresponding to a selected type of finishing for the same element. The different specification is configured in a manner that the desired specification is achieved once the element is printed according to the different specification and finished according to the selected type of finishing.

The selection of the type of gloss of a varnish or laminate (e.g., gloss, semigloss, matte) may also specify application of certain actions or rules of box 52. More specifically, screening may be used to enhance a gloss level. A screening operator (e.g., screening LUT, algorithm or other arrangement) may be used to select certain screens to achieve desired different gloss levels in the finished output of the job for different elements as selected in respective varnish or laminate tags.

As discussed above, various image enhancements may be applied to picture elements according to the actions or rules as defined by tags of the pictures. The image data of the appropriate pictures may be modified according to the actions or rules to implement changes of resolution, sharpening, smoothing, and contrast in some examples.

Actions or rules selected by tags may also control operations with respect to GCR levels. In one embodiment, desired GCR levels may be specified for one or more elements by respective tags and the output is generated in accordance with the defined GCR levels. Different GCR levels may be specified to provide elements of desired low or high qualities and in consideration of finishing operations to be performed in some examples.

In an additional example, the actions or rules may control one or more parameters of the printer used to hard image the elements of the job and corresponding to the tags of the respective elements. Some examples of parameters of the printer which may be controlled include insertion of null cycles after pages are printed, printing temperatures, laser powers, and timing parameters corresponding to the desired printing of elements as defined by the tags.

The above-described tags and actions or rules may control the operations of the print workflow including proofing 54, ripping/rendering 56, printing 58, inspection 60 and finishing 62 in one embodiment. Respective apparatus 30 of the print shop 22 and finisher 24 are configured to implement the actions or rules in one embodiment.

Proofing 54 may correspond to a soft proof operation performed by designer 20 in one embodiment. Tags may be used to identify elements of variable content, and accordingly, specify which elements may be disregarded during reviewing of the job (e.g., proofing 54) as not including fixed content in one example. In another example, proofing may be limited to elements 13 which are tagged as including variable content. The actions or rules may control operations (e.g., color transformations, screening) during ripping/rendering 56 by print shop 22 in one embodiment. The actions or rules may additionally control process parameters of the print engine 38 to print the elements of the job in one embodiment. Similar to proofing 54, an inspection 60 may be performed of printed output of a job in one embodiment. In some embodiments, the inspection process is automated by the use of an inspection station (e.g., scanner) which may be embodied within finisher 24 in one arrangement to verify the printed job prior to finishing. Elements which are tagged as including variable content may be disregarded during reviewing and verification of the inspection process to reduce the occurrence of indications of printed output being out of specification from the designed job. Tags of the elements may be accessed by the finisher 24 to specify the finishing operations (e.g., varnish, laminate) for the respective elements of a page of the job.

Referring to FIG. 6, one embodiment of a print workflow method is shown to provide a varnish on at least one or more element of a page. The print work flow may be performed by one or more of the entities of FIG. 2 in one embodiment. Other print workflow methods are contemplated including more, less or alternative acts.

At an Act A20, an author creates and tags elements of a page. One or more of the elements may be tagged in a manner to specify application of a particular varnish to the respective elements. The varnish may be marked as transparent, however, the spectral properties of the colors of the elements to be varnished are typically altered by the varnish.

At an Act A22, the author may specify whether the print workflow process is to produce anticipating varnish or for net color. The process may proceed directly to Act A26 if Act A22 is in the negative.

Otherwise, at an Act A24, an appropriate operator to account for the color shift of the specified varnish is accessed.

At Act A26, the RIP processes image data of the elements of the page, for example, using ICC profiles, desired screens, etc. in accordance with the tags. Furthermore, the operator of Act A24 is utilized to process the undervarnished regions (i.e., respective elements to be varnished) to account for the subsequent varnishing if the operator selects process with varnish anticipated.

At an Act A28, the processed image data is utilized to print the page.

At an Act A30, the respective appropriate elements of the printed page are varnished according to the tags.

At an Act A32, the varnished page may be checked for example using a spectrophotometer to ensure the final color matches the desired effect. A failed check may indicate that adjustment of the operator accessed at Act A24 is appropriate if such was utilized in the processing of Act A26.

Referring to Table A, an example is shown illustrating results of corrections provided by an appropriate operator for lamination.

TABLE A

| | | | Unlaminated ICC Profile | | | | | | | | | | Laminated ICC Profile | | | | | | |
|---|---|---|---|---|---|---|---|---|---|---|---|---|---|---|---|---|---|---|---|
| | | | | | | | Measured | | | Measured | | | | | | | Measured | | |
| Target | | | | | | | Unlaminated | | | Laminated | | | | | | | Laminated | | |
| Colors | | | Printer Values | | | | Prints | | | Prints | | | Printer Values | | | | Prints | | |
| L* | a* | b* | c | m | y | k | L* | a* | b* | L* | a* | b* | c | m | y | K | L* | a* | b* |
| 95 | 0 | 0 | 4 | 4 | 3 | 0 | 95 | 1 | −1 | 93 | 1 | −1 | 2 | 2 | 1 | 0 | 95 | 0 | 0 |
| 78 | 0 | 0 | 29 | 33 | 27 | 0 | 78 | 0 | 0 | 73 | −1 | 0 | 21 | 25 | 20 | 0 | 78 | 0 | 0 |
| 60 | 0 | 0 | 52 | 58 | 47 | 4 | 60 | 0 | 0 | 55 | 0 | 1 | 46 | 52 | 41 | 1 | 60 | 0 | 0 |
| 43 | 0 | 0 | 72 | 74 | 67 | 27 | 44 | 0 | 1 | 37 | 0 | 1 | 65 | 69 | 58 | 14 | 43 | 0 | 0 |
| 25 | 0 | 0 | 84 | 84 | 92 | 81 | 26 | 0 | −1 | 16 | −1 | 3 | 82 | 85 | 79 | 52 | 25 | 0 | 0 |

In Table A, the target colors are the desired colors to be printed. The printer values show the values used to obtain the printing of the target colors without the use of the operator (e.g., unlaminated ICC profile in Table A) and with the use of the operator (e.g., laminated ICC profile). As shown, the measurements of the unlaminated prints with the unlaminated ICC profile generally correspond to the target colors. However, the prints are changed from the target once laminated (e.g., yellow is increased by the usage of the lamination). As shown in Table A, the measurements of the laminated prints resulting from the use of the laminated ICC profile correspond to the target values. In one embodiment, the operator may be an appropriate LUT to provide the printer values of the laminated ICC profile instead of the printer values of the unlaminated ICC profile. The printer values of the laminated ICC profile provide reduced yellow (compared with that intended by the target values) and the yellow will be enhanced by the subsequent lamination in this example to achieve the desired result.

According to at least one embodiment, individual elements of a single page of a job may be tagged differently to specify one or more of processing the image data of the elements differently, printing image data of the elements differently, and finishing the elements differently. For example, a tag may specify a varnish or laminate to be applied to one of the elements which will alter the spectral properties of the colors of the element which were printed prior to the varnish or lamination. According to one implementation, a respective operator corresponding to the specified varnish or laminate may be selected using the tag to modify the image data of the element during processing and prior to printing of the element. For example, a color shift of the image data may be implemented to provide the printed element configured to accommodate the subsequently applied varnish or lamination (as shown in Table A) yielding the final result in accordance with the intended design of the author.

Hard imaging and finishing of a page of the job may be performed in a plurality of separations. For example, the separations correspond to respective different steps of applying different materials to a page (e.g., respective separations may include respective separate applications of individual colors, varnishes, laminates, etc. to a page in respective steps). The tags may specify that a plurality of elements of a single page are to be one or more of processed, printed and finished differently. For example, during processing of image data, one screen may be used for one element not receiving a laminate while another different screen may be used for a different element of the same page which is to receive the laminate. In one embodiment, a respective operator may be identified using a tag of the element to be laminated to select a screen for the laminated element which is different than a screen initially selected to process the page including the elements. The different screens (e.g., initial and operator selected) may be used for the different elements of the same page during one or more of the separations in the described example.

Some of the disclosed embodiments above describe modifications of processing, printing, and finishing, to account for finishing which may occur after printing. In other embodiments, modifications of image data may also be implemented to account for specialized media, such as underprinted metal substrates and underlayments (e.g., Sapphire coating, White underlayment) which may also alter spectral properties of colors subsequently printed upon the media. Tags may be used to identify the media and to implement appropriate modifications in one embodiment.

As is evident from the foregoing, some embodiments of the disclosure describe apparatus and methods for implementing a print workflow including processing, printing and finishing of jobs. At least one embodiment discloses tagging which associates individual tags with respective elements of one or more pages of a job to specify desired processing, printing and finishing of the elements during a print workflow. The tags may specify different processing, printing and finishing of different elements of a single page of the job in one embodiment. These methods and apparatus enable processing, printing and finishing of a job in a manner optimized to the respective different elements being printed in the job. Described methods and apparatuses of this embodiment provide increased flexibility to authors during design of the job compared with arrangements which only permit page level specifications. According to one embodiment, operations to be performed after a job is printed (e.g., finishing of elements) may be taken into account before the job is printed to provide resultant jobs which more accurately reflect the intent of the author and with fewer iterations of printing and finishing to achieve a desired result.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure

The protection sought is not to be limited to the disclosed embodiments, which are given by way of example only, but instead is to be limited only by the scope of the appended claims.

What is claimed is:

1. A print workflow method comprising:
providing a job to be printed upon media comprising:
arranging a plurality of elements into a desired layout for a page of the job; and
tagging individual ones of the elements of the job with respective ones of a plurality of different tags; and
hard imaging the job in a plurality of separations and according to the tags, the hard imaging comprising:
accessing the job comprising the elements and the respective tags of the page;
processing the page of the job for printing; and
after the processing, printing the page of the job comprising the plurality of elements; and
after the printing, finishing the job; and
wherein at least one of the processing, the printing and the finishing for a single one of the separations comprises processing, printing, or finishing different ones of the elements of the page differently according to the respective tags.

2. The method of claim 1 wherein the tags associated with different ones of the elements specify different operations to be performed with respect to the different ones of the elements during the at least one of the processing, the printing or the finishing.

3. The method of claim 1 wherein the tagging comprises receiving user input and assigning one of the tags to one of the elements using the user input.

4. The method of claim 1 wherein the tagging comprises automatically assigning one of the tags to one of the elements using processing circuitry and without user input.

5. The method of claim 4 wherein the tagging comprises identifying a type of the one of the elements, and the automatically assigning comprises automatically assigning the one of the tags using the identified type of the one of the elements.

6. The method of claim 1 wherein the processing comprises processing the different ones of the elements differently for the respective single separation according to the respective tags.

7. The method of claim 1 wherein the printing comprises printing the different ones of the elements differently for the respective single separation according to the respective tags.

8. The method of claim 1 wherein the finishing comprises finishing the different ones of the elements differently for the respective single separation according to the respective tags.

9. The method of claim 1 wherein one of the tags of one of the elements is configured to cause selection of one of a plurality of different types of finishing of the one of the elements during the finishing of the job, and wherein the processing comprises modifying image data of the one of the elements to account for the one of the different types of finishing of the one of the elements.

10. The method of claim 1 wherein the tagging comprises tagging one of the elements as comprising variable content, and further comprising:
reviewing portions of the job; and
controlling the reviewing to disregard the one of the elements comprising the variable content responsive to the tagging of the one of the elements as comprising the variable content.

11. The method of claim 1 further comprising identifying respective ones of a plurality of rules corresponding to the tags of the different ones of the elements, and wherein the at least one of the processing, the printing or the finishing the different ones of the elements is responsive to the identified ones of the rules.

12. A print workflow method comprising:
accessing a job to be printed and finished;
accessing a tag associated with an element of the job and configured to cause selection of one of a plurality of different types of finishing for the element;
printing the page of the job including the element upon media, and wherein the printing of the element is modified corresponding to the selected type of finishing for the element; and
finishing the job after the printing, wherein the finishing comprises finishing the element corresponding to the selected type of finishing for the element.

13. The method of claim 12 wherein the finishing comprises applying material over the element printed upon the media, and wherein the printing of the element comprises modifying image data of the element to account for the material, and printing the element using the image data of the element after the modifying.

14. The method of claim 12 further comprising:
designing the job comprising the element;
tagging the element of the job with the tag; and
wherein the designing comprises designing the element to be printed according to a first specification, and wherein the printing of the element comprises modifying the first specification to a second specification different than the first specification and corresponding to the selected type of finishing for the element.

15. The method of claim 14 wherein the second specification for the element and the selected type of finishing correspond to the first specification for the element.

16. A printing system apparatus comprising:
processing circuitry configured to access a job to be printed, wherein the job comprises a page comprising a plurality of elements and a plurality of tags associated with respective ones of the elements, wherein the processing circuitry is configured, for an individual one of the elements, to process the respective tag associated with the individual one of the elements and to modify image data of the one of the elements according to the respective tag associated with the one of the elements; and
a print engine coupled with the processing circuitry and configured to print the page comprising the plurality of the elements, and wherein the print engine is configured to print the one of the elements using the image data after the modification.

17. The apparatus of claim 16 wherein the processing circuitry is configured, for another of the elements, to process the respective tag associated with the another of the elements and to modify image data of the another of the elements according to the respective tag associated with the another of the elements, wherein the modifications to the respective image data of the one and the another of the elements are different, and wherein the modified image data of the one and the another of the elements is used during printing of a single separation of the page by the print engine.

18. The apparatus of claim 16 wherein the respective tag associated with the one of the elements identifies one of a plurality of different types of finishing of the one of the elements, and further comprising a finisher configured to finish the job after printing of the page by the print engine including finishing the one of the elements according to the respective tag associated with the one of the elements.

19. The apparatus of claim 18 wherein the processing circuitry is configured to modify the image data to account for the identified one of the different types of finishing of the one of the elements.

20. The apparatus of claim 16 further comprising an inspection station configured to inspect the job after printing of the page by the print engine, and wherein the inspection station is configured to disregard inspection of another of the elements responsive to a tag associated with the another of the elements.
